(19) United States
(12) Patent Application Publication
(10) Pub. No.: US 2017/0040084 A1
(43) Pub. Date: Feb. 9, 2017

(54) TRANSPARENT CONDUCTIVE FILM AND METHOD FOR MANUFACTURING THE SAME

(71) Applicant: INDUSTRIAL TECHNOLOGY RESEARCH INSTITUTE, Hsinchu County (TW)

(72) Inventors: Shin-Liang Kuo, Taipei (TW); Shu-Jiuan Huang, Taipei (TW); Chih-Ming Hu, Kaohsiung (TW)

(21) Appl. No.: 15/297,664

(22) Filed: Oct. 19, 2016

Related U.S. Application Data
(63) Continuation-in-part of application No. 12/419,562, filed on Apr. 7, 2009.

(30) Foreign Application Priority Data
Aug. 12, 2008 (TW) 097130658

(51) Int. Cl. H01B 1/18; C08J 7/06

(52) U.S. Cl. CPC H01B 1/18; C08J 7/06; C08J 2367/02

(57) ABSTRACT

The disclosed is a transparent conductive film and method for manufacturing the same. First, a substrate is provided. Subsequently, an inorganic layer composed of nano-inorganic compound is formed overlying the substrate. A carbon nanotube dispersion is then coated on the inorganic layer and dried to form a carbon nanotube conductive layer.

### CROSS REFERENCE TO RELATED APPLICATIONS

This Application is a Continuation-In-Part of pending U.S. patent application Ser. No. 12/419,562, filed on Apr. 7, 2009 and entitled “Transparent conductive film and method for manufacturing the same”, which claims priority of Taiwan Patent Application No. 97130658, filed on Aug. 12, 2008, the entirety of which is incorporated by reference herein.

### TECHNICAL FIELD

The disclosure relates to a transparent conductive film, and in particular relates to the method and structure for improving conductance of transparent conductive films.

### BACKGROUND

The carbon nanotube, disclosed by Ijima in 1991, was a very important disclosure due to the individual physical and chemical properties of the carbon nanotube, which can be applied to electromagnetic wave shield and static dissipative additive, adsorption material, and energy storage device (e.g. lithium secondary battery, super capacitor, and fuel cell). Additionally, due to increasing cost of ITO transparent conductive oxide, limitation on manufacture of large-scale conductive film, and development of flexible electronics, high conductivity, low absorption of visible light, and high mechanical properties make carbon nanotube a potential candidate for transparent conductive film. Forecast industry size of the carbon nanotube industry is about tens of million dollars. However, conductance of conventional carbon nanotube transparent conductive films is determined by inherency, dispersibility, and morphology of CNT network structure. Specifically, differently prepared and structured carbon nanotubes have very different electrical properties, such that the conductivities therebetween may differ. For film with better conductance, single walled carbon nanotubes with high purity are required. In addition to the selection and purification of the carbon nanotube, the conductance of the carbon nanotube film can be enhanced by surface modification by SOCl₂ or Br₂. However, the described chemical modifiers are toxic and not suitable for mass production.

The carbon nanotube based transparent conductive films typically comprises single layered conductive layer. In addition to the carbon nanotube, the conductive layer may further include polymer resins, conductive metal oxides, or other substances. There are no specific designs for conductive films. In U.S. Pat. No. 5,098,771, carbon nano fiber is applied as a conductive paint and conductive ink. The formula includes carbon nano fibers and polymer binder is sprayed to form a conductive film. In U.S. Pat. No. 5,853,877, a transparent conductive film is prepared from acidified carbon nanotubes. The acidified carbon nanotube is added to polar solvent to form a dispersion. The dispersion is added a polymer dispersant or binder, and then spin-coated to form a transparent conductive film. In U.S. Pat. No. 5,908,585, the composition of coating solution for the transparent conductive film will be emphasized. 0.01˜10% o carbon nanotube and 1˜40% transparent conductive oxides such as antimony doped tin oxide were selected to prepare the dispersion. The dispersion was then added resin or gel to form a conductive coating formula. In U.S. Pat. No. 7,060,241, single walled carbon nanotube with a specific tube diameter (less than 3.5 nm) was selected to be raw material for forming a film with better conductance and transparency. In Japan Patent No. 2005336341, the composite of carbon nanotube and conductive polymer served to be conductive layer material. Other patents associated with carbon nanotube transparent conductive film focus on the polymer binder composition and

methods for forming a film. In US 2003/0165418, the carbon nanotubes are grown from a SiO₂ layer, and the carbon nanotubes are aligned to each other (not interlaced to each other to from a network) and substantially vertical to the surface of the SiO₂ layer (not extending along the surface of the SiO₂ layer).

Accordingly, a novel transparent conductive film structure and composition for improving the conductance of the original single layered carbon nanotube conductive film is called for.

### SUMMARY

One embodiment of the disclosure provides a transparent conductive film, comprising: a substrate, wherein the substrate is selected from a group consisting of glass, plastic, and synthetic resin; an inorganic layer formed on the substrate, wherein the inorganic layer is composed of a nano-inorganic compound, and the nano-inorganic compound is silicon oxide, silica alumina clay, vermiculite, tubular kaolin, sericite, bentonite, mica, or combinations thereof; and a carbon nanotube conductive layer comprising carbon nanotubes overlying and contacting the inorganic layer, wherein the carbon nanotubes lie on and extend along the surface of the inorganic layer, wherein the inorganic layer is disposed between the substrate and the carbon nanotube conductive layer, and the inorganic layer directly contacts the substrate.

One embodiment of the disclosure provides a method for forming a transparent conductive film, comprising: providing a substrate, wherein the substrate is selected from a group consisting of glass, plastic, and synthetic resin; forming an inorganic layer on the substrate, wherein the inorganic layer is composed of a nano-inorganic compound, and the nano-inorganic compound is silicon oxide, silica alumina clay, vermiculite, tubular kaolin, sericite, bentonite, mica, or combinations thereof; coating a carbon nanotube dispersion on the inorganic layer; and drying the carbon nanotube dispersion to form a carbon nanotube conductive layer comprising carbon nanotubes overlying and contacting the inorganic layer, wherein the carbon nanotubes lie on and extend along the surface of the inorganic layer, wherein the inorganic layer is disposed between the substrate and the carbon nanotube conductive layer, and the inorganic layer directly contacts the substrate.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1-2 are cross sections showing the flow of forming a transparent conductive film structure in embodiments of the disclosure.

FIGS. 3-6 are top-view SEM photographs of the carbon nanotubes on the inorganic layer in Examples of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

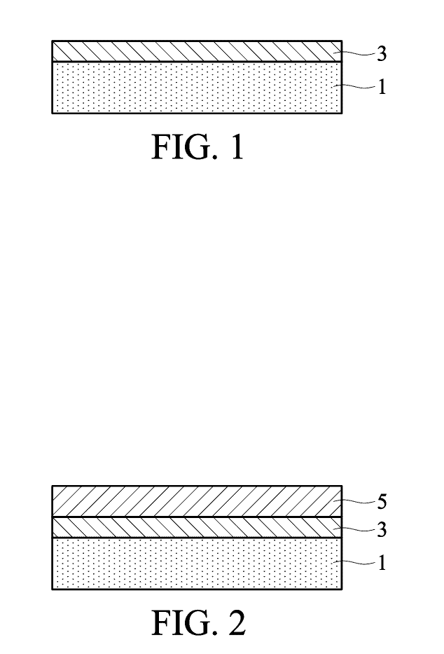

As shown in FIG. 1, an inorganic layer 3 is formed on a substrate 1. The material selection of the substrate 1 includes inorganic compound such as glass or organic compound such as plastic or synthetic resin. The plastic can be poly(ethylene terephthalate) (PET), polyethylene (PE), polypropylene (PP), polycarbonate (PC), polystyrene (PS), acrylonitrile-butadiene-styrene copolymer (ABS), or other general plastics. The synthetic resin includes novolac resin, urea formaldehyde resin, unsaturated polyester resin, melamine resin, polyurethane resin, alkyd resin, epoxy resin, polyvinyl acetate resin, petroleum resin, polyamide resin, furan resin, maleic anhydride resin, and the likes.

The inorganic layer 3 is composed of nano-inorganic compound having at least one dimension (length, width, and/or thickness) of 0.5 nm to 100 nm. The nano-inorganic compound can be oxide, silicate, hydroxide, carbonate, sulfate, phosphate, sulfide, or combinations thereof The suitable oxide includes silicon oxide, tin oxide, titanium oxide, zinc oxide, aluminum oxide, zirconium oxide, indium oxide, antimony oxide, tungsten oxide, yttrium oxide, magnesium oxide, cerium oxide, doped oxides thereof, or combinations thereof The silicate includes silica alumina clay, vermiculite, tubular kaolin, sericite, bentonite, mica, or combinations thereof The method for forming the inorganic layer 3 can be by a wet process such as coating or dry process such as deposition or sputtering. In one embodiment, the inorganic layer 3 adopts a metal oxide such as titanium oxide or tin oxide, such that the solution containing nano metal oxides with a size of about 10 nm can be formed by a sol-gel method. Thereafter, the solution is coated on the substrate 1 by wire bar and then dried to form the inorganic layer 3. In another embodiment, a commercially available nano-scaled silicon dioxide or clay is dispersed in methyl ethyl ketone (MEK) or water to prepare the dispersion. The dispersion is coated on the substrate 1 and then dried to form the inorganic layer 3.

Subsequently, a carbon nanotube dispersion is prepared. The dispersion is basically composed of carbon nanotube, dispersant, and water.

The carbon nanotube includes a single walled carbon nanotube, multi walled carbon nanotube, or combinations thereof The carbon nanotube has a tube diameter of 0.7 nm to 100 nm.

The dispersant is utilized to avoid aggregation of the carbon nanotube, such that the carbon nanotube is uniformly dispersed in water. The dispersant is a typical surfactant such as an anionic surfactant, cationic surfactant, nonionic surfactant, zwitterionic surfactant, or combinations thereof

A suitable anionic surfactant can be sodium salt, magnesium salt, or ammonium salt of alkyl sulphates, alkyl ether sulphates, alkaryl sulphonates, alkanoyl isethionates, alkyl succinates, alkyl sulphosuccinates, N-alkoxyl sarcosinates, alkyl phosphates, alkyl ether phosphates, alkyl ether carboxylates or alpha-olefin sulphonates.

A suitable nonionic surfactant can be an aliphatic (C₈₋₁₈) primary or secondary linear or branched alcohol or phenol accompanied with an alkylene oxide. In one embodiment, the alkylene oxide is composed of 6 to 30 ethylene oxides. Other nonionic surfactant like alkanolamides can be substituted by one or two alkyl groups, such as coco ethanolamide, coco di-ethanolamide, coco isopropanolamide, or the likes.

The described zwitterionic surfactant can be alkyl amine oxides, alkyl betaines, alkyl amidopropyl betaines, alkyl sulphobetaines, alkyl sulphobetaines, alkyl glycinates, alkyl carboxyglycinates, alkyl amphopropionates, alkyl amphoglycinates, alkyl amidopropyl hydroxysultainates, acyl taurates, or acyl glutamates. The described alkyl can be a C₈₋₁₉ alkyl group. For example, the zwitterionic surfactant also includes lauryl amine oxide, cocodimethyl sulphopropyl betaine, lauryl betaine, cocamidopropyl betaine, or sodium cocamphopropionate.

In one embodiment, the carbon naotube dispersion may further include a nano-inorganic compound similar to the inorganic layer 3, a polymer, a binder, or combinations thereof As such, the mechanical properties such as adhesion between the carbon nanotube conductive layer and the inorganic layer 3 can be enhanced to prevent product lamination due to external strike or compression.

Lastly, the carbon nanotube dispersion is coated on the inorganic layer 3, and then dried to form the carbon nanotube conductive layer 5 comprising carbon nanotubes overlying and contacting the inorganic layer, wherein the carbon nanotubes lie on and extend along the surface of the inorganic layer 3, as shown in FIG. 2. The coating step can be continued for multiple of times to form thicker carbon nanotube conductive layers 5. It is understood that thicker carbon nanotube conductive layer 5 has better conductance but lower transparency. On the other hand, the thinner carbon nanotube conductive layer 5 has worse conductance but higher transparency. In related art, the thicker carbon nanotube layer is adopted to enhance conductance, thereby sacrificing transparency thereof The transparent inorganic layer 3 is disposed between the substrate 1 and the carbon nanotube conductive layer 5, thereby efficiently improving conductance of the carbon nanotube conductive layer 5. Accordingly, it is not necessary to increase the carbon nanotube conductive layer 5 thickness for sufficient conductance, thereby simultaneously achieving conductance and transparency.

In the disclosure, the carbon nanotube conductive layer is formed by preparing the carbon nanotube dispersion, then wet coating the carbon nanotube dispersion, and then drying the carbon nanotube dispersion. Regardless of whether the carbon nanotubes are single walled or multi-walled, the carbon nanotubes cannot extend along a direction vertical to the surface of the inorganic layer during the wet coating and the drying steps due to the high aspect ratio and non-rigid structure of the carbon nanotubes. As a result, the carbon nanotubes overlying and contacting the inorganic layer will extend along the surface of the inorganic layer, thereby forming a carbon nanotube network of the interlaced carbon nanotube.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

SiO₂ sol dispersed in MEK (4730S, commercially available from Changchun Chemical) was coated on a PET film (A4100, commercially available from Toyobo) by a wire bar, and then dried to form an inorganic layer on the PET film.

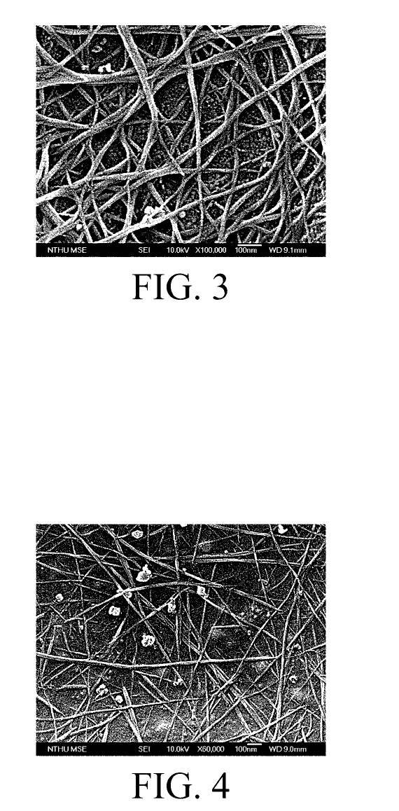

Subsequently, 0.02 g of single walled carbon nanotube (ASP-100F, commercially available from Ijin) and 0.02 g of sodium dodecylbenzenesulfonate (commercially available from Fluka) were added to 10.0 g of water, and ultrasonic vibrated to form a carbon nanotube dispersion. The dispersion was coated on the inorganic layer by a wire bar and then dried to form a carbon nanotube conductive layer comprising carbon nanotubes overlying and contacting the inorganic layer, wherein the carbon nanotubes lie on and extend along the surface of the inorganic layer, as shown in FIG. 3. The carbon nanotubes were interlaced to form a network. As such, the transparent conductive film was completed.

The transparency of the transparent conductive film was measured with a 550 nm wavelength light as the standard. The transparency sum of the PET film and the inorganic layer was considered as background value. The transparency of the transparent conductive film was 95.1% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of

1.4*10³Ω/□.

### Example 2

Similar to Example 1, the difference in Example 2 was that the inorganic solution composed of antimony-doped tin oxide (Sb:SnO₂) was prepared by a sol-gel method. For the sol-gel method, please refer to experiments in J. Electrochem. Soc., 148, A550 (2001). 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 95.1% (without the background value) and a sheet resistance of

1.5*10³Ω/□.

### Example 3

Similar to Example 1, the difference in Example 3 was that the inorganic solution composed of titanium oxide (TiO₂) was prepared by a sol-gel method. For the sol-gel method, please refer to Japan patent No. 2001104797. 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer. As such, the transparent conductive film was completed.

The measurements of transparency and sheet resistance of the transparent conductive film were similar to those of Example 1. The transparent conductive film had a transparency of 94.0% (without the background value) and a sheet resistance of

1.7*10³Ω/□.

### Example 4

Similar to Example 1, the difference in Example 4 was that the inorganic solution was clay dispersion (SWN, commercially available from CO-OP). 1.0 g of the inorganic solution was coated on the PET film (A4100, commercially available from Toyobo) by a wire bar and then dried to form an inorganic layer on the PET film.

Subsequently, the carbon nanotube dispersion of Example 1 was coated on the inorganic layer by a wire bar and then dried to form a carbon nanotube conductive layer comprising carbon nanotubes overlying and contacting the inorganic layer, wherein the carbon nanotubes lie on and extend along the surface of the inorganic layer, as shown in FIG. 4. The carbon nanotubes were interlaced to form a network. As such, the transparent conductive film was completed.

The measurements of transparency and sheet resistance of the transparent conductive film were similar to those of Example 1. The transparent conductive film had a transparency of 96.6% (without the background value) and a sheet resistance of

2.5*10³Ω/□

### Example 5

Similar to Example 1, the difference in Example 5 was that the carbon nanotube dispersion was added 0.3 g of silicon dioxide sol (Besil-30A, commercially available from A-Green Co. Ltd).

1.0 g of the inorganic solution of Example 1 was coated on the PET film (A4100, commercially available from Toyobo) by a wire bar and then dried to form an inorganic layer on the PET film.

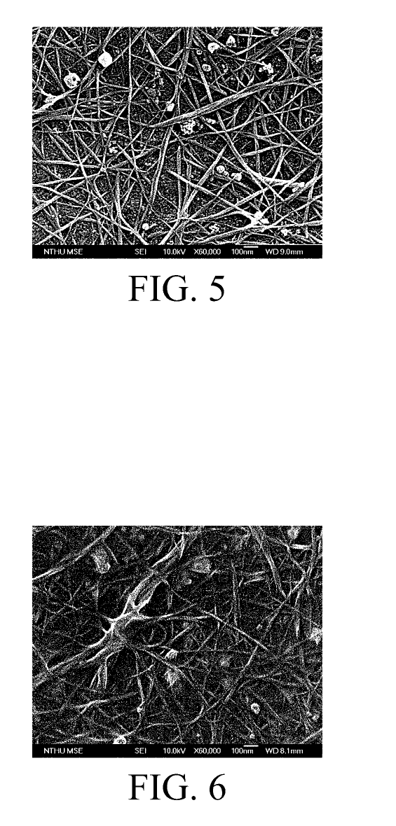

Subsequently, the carbon nanotube dispersion with silicon dioxide sol was coated on the inorganic layer by a wire bar and then dried to form a carbon nanotube conductive layer comprising carbon nanotubes (and silicon oxide particles) overlying and contacting the inorganic layer, wherein the carbon nanotubes lie on and extend along the surface of the inorganic layer, as shown in FIG. 5. The carbon nanotubes were interlaced to form a network. As such, the transparent conductive film was completed.

The measurements of transparency and sheet resistance of the transparent conductive film were similar to those of Example 1. The transparent conductive film had a transparency of 93.5% (without the background value) and a sheet resistance of

1.2*10³Ω/□

### Comparative Example 1

The carbon nanotube dispersion of Example 1 was directly coated on the PET film (A4100, commercially available from Toyobo) by a wire bar, and then dried to form a carbon nanotube conductive layer comprising carbon nanotubes overlying and contacting the PET film, wherein the carbon nanotubes lie on and extend along the surface of the PET film, as shown in FIG. 6. The carbon nanotubes were interlaced to form a network. The difference between Comparative Example 1 and Example 1 was that no inorganic layer was disposed between the substrate and the carbon nanotube conductive layer in Comparative Example 1.

The transparency of the transparent conductive film was measured with a 550 nm wavelength light as the standard. The transparency PET film layer was considered as background value. The transparency of the transparent conductive film was 94.7% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of

7.0*10³Ω/□.

As shown when comparing Examples 1-5 and Comparative Example 1, the transparent conductive film including the inorganic layer showed better conductance. The Examples 1-5, were 3 to 6 times the conductance of the Comparative Example 1, without sacrificing the transparency.

### Example 6

1.0 g of SiO₂ sol dispersed in MEK (4730S, commercially available from Changchun Chemical) was coated on a PET film (A4100, commercially available from Toyobo) by a wire bar, and then dried to form an inorganic layer on the PET film.

Subsequently, 0.05 g of multi walled carbon nanotube (Nanocyl-7000, commercially available from Nanocyl) and 0.05 g of sodium dodecylbenzenesulfonate (commercially available from Fluka) were added to 10.0 g of water, and ultrasonic vibrated to form a carbon nanotube dispersion. The dispersion was coated on the inorganic layer by a wire bar and then dried to form a carbon nanotube conductive layer. As such, the transparent conductive film was completed.

The transparency of the transparent conductive film was measured with a 550 nm wavelength light as the standard. The transparency sum of the PET film and the inorganic layer was considered as background value. The transparency of the transparent conductive film was 88.0% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of

1.0*10⁴Ω/□.

### Example 7

Similar to Example 6, the difference in Example 7 was that the inorganic solution was clay dispersion (SWN, commercially available from CO-OP). 1.0 g of the inorganic solution was coated on the PET film (A4100, commercially available from Toyobo) by a wire bar and then dried to form an inorganic layer on the PET film.

Subsequently, the carbon nanotube dispersion of Example 6 was coated on the inorganic layer by a wire bar and then dried to form a carbon nanotube conductive layer. As such, the transparent conductive film was completed.

The measurements of transparency and sheet resistance of the transparent conductive film were similar to those of Example 6. The transparent conductive film had a transparency of 89.5% (without the background value) and a sheet resistance of

2.4*10⁴Ω/□.

### Example 8

Similar to Example 6, the difference in Example 8 was that the inorganic solution composed of titanium oxide (TiO₂) was prepared by a sol-gel method. For the sol-gel method, please refer to Japan patent No. 2001104797. 1.0 g of the inorganic solution was coated on the PET film (A4100, commercially available from Toyobo) by a wire bar and then dried to form an inorganic layer on the PET film.

Subsequently, the carbon nanotube dispersion of Example 6 was coated on the inorganic layer by a wire bar and then dried to form a carbon nanotube conductive layer. As such, the transparent conductive film was completed.

The measurements of transparency and sheet resistance of the transparent conductive film were similar to those of Example 6. The transparent conductive film had a transparency of 89.9% (without the background value) and a sheet resistance of

1.9*10⁴Ω/□.

### Comparative Example 2

The carbon nanotube dispersion of Example 6 was directly coated on the PET film (A4100, commercially available from Toyobo) by a wire bar, and then dried to form a carbon nanotube conductive layer. The difference between Comparative Example 2 and Example 6 was that no inorganic layer was disposed between the substrate and the carbon nanotube conductive layer in Comparative Example 2.

The transparency of the transparent conductive film was measured with a 550 nm wavelength light as the standard. The transparency PET film layer was considered as background value. The transparency of the transparent conductive film was 89.4% (without the background value).

The sheet resistance of the transparent conductive film was measured by a 4-point probe sheet resistance testing system (LORESTA-GP, commercially available from Mitsubishi Chemical Co.). The transparent conductive film had a sheet resistance of

5.6*10⁴Ω/□.

As shown when comparing Examples 6-8 and Comparative Example 2, the transparent conductive film including the inorganic layer had better conductance. Examples 6-8 showed 3 to 6 times the conductance of the Comparative Example 2, without sacrificing transparency.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A transparent conductive film, comprising:
a substrate, wherein the substrate is selected from a group consisting of glass, plastic, and synthetic resin;
an inorganic layer formed on the substrate, wherein the inorganic layer is composed of a nano-inorganic compound, and the nano-inorganic compound is silicon oxide, silica alumina clay, vermiculite, tubular kaolin, sericite, bentonite, mica, or combinations thereof; and
a carbon nanotube conductive layer comprising carbon nanotubes overlying and contacting the inorganic layer, wherein the carbon nanotubes lie on and extend along the surface of the inorganic layer,
wherein the inorganic layer is disposed between the substrate and the carbon nanotube conductive layer, and the inorganic layer directly contacts the substrate.

2. The transparent conductive film as claimed in claim 1, wherein the substrate comprises glass, plastic, or synthetic resin.

3. The transparent conductive film as claimed in claim 1, wherein the nano-inorganic compound has at least one dimension of 0.5 nm to 100 nm.

4. The transparent conductive film as claimed in claim 1, wherein the carbon nanotube of the carbon nanotube conductive layer has a tube diameter of 0.7 nm to 100 nm.

5. The transparent conductive film as claimed in claim 1, wherein the carbon nanotube conductive layer further comprises an additional nano-inorganic compound, a polymer, a binder, or combinations thereof

6. The transparent conductive film as claimed in claim 1, wherein the carbon nanotubes are interlaced to form a network.

7. A method for forming a transparent conductive film, comprising:
providing a substrate, wherein the substrate is selected from a group consisting of glass, plastic, and synthetic resin;
forming an inorganic layer on the substrate, wherein the inorganic layer is composed of a nano-inorganic compound, and the nano-inorganic compound is silicon oxide, silica alumina clay, vermiculite, tubular kaolin, sericite, bentonite, mica, or combinations thereof;
coating a carbon nanotube dispersion on the inorganic layer; and
drying the carbon nanotube dispersion to form a carbon nanotube conductive layer comprising carbon nanotubes overlying and contacting the inorganic layer, wherein the carbon nanotubes lie on and extend along the surface of the inorganic layer,
wherein the inorganic layer is disposed between the substrate and the carbon nanotube conductive layer, and the inorganic layer directly contacts the substrate.

8. The method as claimed in claim 7, wherein the substrate comprises glass, plastic, or synthetic resin.

9. The method as claimed in claim 7, wherein the step of forming the inorganic layer comprises a coating, deposition, or sputtering process.

10. The method as claimed in claim 7, wherein the nano-inorganic compound has at least one dimension of 0.5 nm to 100 nm.

11. The method as claimed in claim 7, wherein the carbon nanotube dispersion comprises the carbon nanotubes, a dispersant, and water.

12. The method as claimed in claim 11, wherein the carbon nanotubes have a tube diameter of 0.7 nm to 100 nm.

13. The method as claimed in claim 11, wherein the carbon nanotube dispersion further comprises an additional nano-inorganic compound, a polymer, a binder, or combinations thereof

14. The method as claimed in claim 7, wherein the carbon nanotubes are interlaced to form a network.
